(19) United States
(12) Patent Application Publication
(10) Pub. No.: US 2013/0213273 A1
(43) Pub. Date: Aug. 22, 2013

(54) PROCESS FOR PRODUCING CEMENT BINDER COMPOSITIONS CONTAINING MAGNESIUM

(71) Applicant: Nikolaos Vlasopoulos, London (GB)

(72) Inventor: Nikolaos Vlasopoulos, London (GB)

(73) Assignee: CALIX LIMITED, Pymble, NSW (AU)

(21) Appl. No.: 13/820,219

(22) PCT Filed: Aug. 18, 2011
(86) PCT No.: PCT/EP2011/064248

§ 371 Date: May 8, 2013

(30) Foreign Application Priority Data
Sep. 2, 2010 (GB) 1014577.9
Sep. 9, 2010 (GB) 1014990.4
Aug. 8, 2011 (EP) PCT/EP2011/063627
Sep. 8, 2011 (EP) PCT/EP2011/063629

(51) Int. Cl. C04B 9/00

(52) U.S. Cl. CPC C04B 9/00
USPC 106/705; 106/801

(57) ABSTRACT

A process for producing a cement binder composition including one or more magnesium carbonates having the general formula w MgCO₃. x MgO. y Mg(OH)₂ . z H₂O in which w is a number equal to or greater than 1, at least one of x, y and z is a number greater than 0 and w, x, y and z may be (but need not be) integers is described. The process is characterised by (a) heating magnesite to liberate carbon dioxide gas and produce a solid product including magnesium oxide and (b) contacting an aqueous mixture including the magnesium oxide produced in step (a) with a source of carbonate ions at a temperature in the range 25 to 120° C. to produce at least one of the magnesium carbonates.

The present invention relates to a process for the production of cement binder compositions comprising one or more magnesium carbonates from magnesite. In particular it relates to a process for preparing certain magnesium carbonates useful as a component in a range of environmentally friendly magnesium cements which are alternatives to Portland Cement) and the like.

Portland cement is a well-known and ubiquitous building material which currently is the most common type of hydraulic cement in general use, It is manufactured on an industrial scale by heating limestone and aluminosilicates together at temperatures up to 1450° C. to generate ‘clinker’ (various calcium silicates and aluminates) which is then blended with other materials e.g. gypsum (calcium sulphate) and other minor additives as required for its given duty. The manufacture of Portland cement is thus a highly energy intensive process and consequently a major source of greenhouse gas emissions. Typically the manufacture of Portland cement emits between 0.65 and 0.8 tonnes of carbon dioxide for every tonne of cement produced. It has been estimated that 5% of all anthropogenic carbon dioxide comes from the cement industry. Not surprisingly therefore cement manufacturers are coming under increasing pressure to reduce these damaging emissions by seeking more energy efficient manufacturing strategies or developing new products which can both be made at lower temperature and retain the required structural properties when used in building materials.

The use of magnesium based cements represents one approach to solving this problem. For example, magnesium oxychloride based cements, or ‘Sorel’ cements, have been known since the mid-nineteenth century whilst the equivalent magnesium oxysulphate materials were first developed in the 1930s. Although both are able to withstand high compressive forces, they suffer from poor water resistance making them unsuitable for external applications where significant weathering occurs. Alternatively, US2005/103235 discloses cement compositions based on magnesium oxide containing no magnesium oxychloride or oxysulphate. Cements made from these materials however take a relatively long time to develop their ultimate compressive strength and therefore remain capable of further improvement.

Recently, our patent application WO2009/156740 has disclosed new cement binder compositions, comprised of a mixture of magnesium oxide and certain specified magnesium carbonates, with considerably improved overall properties which for the first time opens up the possibility of using magnesium cements as a viable economic alternative to Portland cement on a large scale.

One convenient method for making our new materials, disclosed in our co-pending International Application PCT/EP20111063627, involves amongst other steps the preparation of our magnesium carbonates by the carbonation of readily-available magnesium silicate ores (e.g. olivines, serpentines and talc). These materials can thereafter be wholly or partially converted into magnesium oxide by thermal decomposition opening up the possibility of a highly integrated process for making all the essential components of our compositions. Furthermore, by varying the relative proportions of magnesium oxide and magnesium carbonate produced, not only can the hydraulic and structural properties of the final magnesium cement be controlled but also the overall energy demand of the process can be varied. The practical consequences of the latter is that under certain conditions the process can become a net consumer of carbon dioxide an attribute which inter alia has led us to characterise the resulting cements as ‘carbon negative’.

We have now developed an alternative process which enables certain of the cement compositions disclosed in WO2009/15674 to be prepared from either naturally occurring or synthetically produced forms of anhydrous magnesium carbonate (magnesite).

The carbonation of magnesium oxide derived from magnesite is disclosed for example in Hydrometallurgy 53(2) pp. 155-167 (1999) however this reference does not suggest the manufacture of our cement binder compositions.

According to the present invention there is therefore provided a process for producing a cement binder composition comprising one or more magnesium carbonates having the general formula w MgCO₃ . x MgO y Mg(OH)₂. z H₂O in which w is a number equal to or greater than 1, at least one of x, y and z is a number greater than 0 and w, x, y and z may be (but need not be) integers characterised in that the process comprises the steps of (a) heating magnesite to liberate carbon dioxide gas and produce a solid product comprising magnesium oxide, (b) contacting an aqueous mixture comprising the magnesium oxide produced in step (a) with a source of carbonate ions at a temperature in the range 25 to 120° C. to produce at least one of the magnesium carbonates, (c) optionally heating the magnesium carbonate product(s) of step (b) at a temperature from 45 to 500° C. and (d) blending the magnesium carbonate(s) produced in step (b) or optional step (c) with at least magnesium oxide to produce a cement binder composition .

The magnesite used in the process disclosed herein can be derived from any source and the use of both or either of naturally occurring magnesite ore and synthetically generated magnesite is contemplated. Typical sources of synthetically produced magnesite include those materials produced by the carbonation of magnesium-containing silicate ores (especially olivine, serpentine or talc), those produced by treating sea water with carbon dioxide gas in the presence of an inorganic base (e.g. a Group IA metal hydroxide such as sodium hydroxide) and those obtained by reacting magnesium hydroxide or magnesium oxide with carbon dioxide. As far as the carbon dioxide reactant used in such processes is concerned, whilst minor amounts of impurities (e.g. oxides of sulphur and nitrogen) can be tolerated it is preferred that it is relatively pure and certainly free from noxious hydrogen sulphide or mercaptans so that the magnesite produced is as pure as possible. Sources of impure carbon dioxide (e.g. flue gases and the like) should therefore be purified before use.

The magnesium carbonates produced in the process of the present invention are magnesium carbonates having the general formula w MgCO₃ x MgO . y Mg(OH)₂ z H₂O in which w is a number equal to or greater than 1, at least one of x, y and z is a number greater than 0, and w, x, y and z may be (but need not be) integers. Included in this definition are, for example, synthetic products corresponding stoichiometrically to the following naturally occurring hydrated magnesium carbonates: barringtonite (MgCO₃.2H₂O), nesquehonite (MgCO₃.3H₂O), lansfordite (MgCO₃.5H₂O), artinite (MgCO₃.Mg(OH)₂.3H₂O), hydromagnesite (4MgCO₃.Mg(OH)₂.4H₂O), and dypingite (4MgCO₃.Mg(OH)₂.5H₂O). In a preferred embodiment of the present invention the magnesium carbonates produced are those having the general formula MgCO₃.wH₂O wherein w is a number in the range 0.5 to 5, preferably 0.8 to 2.7.

In step (a) of the process, magnesite feedstock is heated in a kiln or calciner to a temperature in the range 500 to 1400° C., preferably in the range of 500 to 1000° C., most preferably in the range of 550 to 800° C. and typically at a pressure of up to 1 MPa. However since the thermal decomposition of magnesite is an equilibrium-controlled process it is preferred to work at as low a pressure as possible all things being otherwise equal. Under these high temperature conditions the magnesite thermally decomposes to produce magnesium oxide thereby liberating carbon dioxide gas which can then be removed. It is preferred that at least part of the carbon dioxide so removed is used to preheat the cold magnesite feedstock and/or effect the carbonation in step (b) and/or as the source of heat in step (c). Step (a) may be carried out batchwise or continuously.

In step (b) of the process, the magnesium oxide produced in step (a) is contacted with a source of carbonate ions in an aqueous medium. Such carbonate ions can be added directly, for example by directly introducing a solid carbonate or bicarbonate salt (e.g. a sodium or potassium carbonate or bicarbonate) into the aqueous medium, or indirectly by contacting the mixture with carbon dioxide in which case carbonate ions are generated in situ. It is also possible to use both sources. Step (b) is suitably carried out at a temperature in the range 25 to 120° C., preferably in the range 25 to 65° C. if the object is to make a nesquehonite type material and 65 to 120° C. if the object is to make a hydromagnesite type material. If step (b) involves the use of carbon dioxide, the partial pressure is preferably up to 1 MPa, more preferably from 0.1 to 1 MPa and most preferably from 0.1 to 0.5 MPa. In such an embodiment it is preferred that steps (a) and (b) are carried out at one and the same carbon dioxide partial pressure within the typical constraints of industrial process technology. If carbonate or bicarbonate salts are used as the source of carbonate ion it is preferred that the molar ratio of magnesium oxide to carbonate ions in step (b) is in the range 1:10 to 10:1 more preferably 1:5 to 5:1 most preferably 1:3 to 3:1. Whilst it is preferred to allow the carbonation reaction of step (b) go to completion it is also contemplated that step (b) may comprise only partial carbonation, for example by using less carbonate ion relative to the magnesium oxide (in molar terms) or, where carbon dioxide gas is employed, by working at lower temperature and pressures and for shorter residence times. Once the carbonation reaction of step (b) has reached the desired level of completion, the solid magnesium carbonate(s) produced can be separated from the aqueous medium using known methods e.g. filtration or the use of a hydrocyclone. The product so obtained may be washed to remove any residual metal salts at this stage if so desired.

Optionally, the magnesium carbonate(s) produced in step (b) can be heated in step (c) to a temperature in the range from 45 to 500° C. to partially remove water of crystallisation and optionally liberate some but not all of the carbon dioxide present as carbonate ion. For example, we have prepared a range of intermediate products by heat-treating nesquehonite at 105, 200 and 400° C. for 1 to 12 hours (see table below). In this study we have found that the partial removal of water of crystallisation alone is preferably effected at a temperature in the range 100 to 250° C. whilst temperatures in the range 250 to 400° C. are preferred if partial removal of carbon dioxide is also required. These heat-treated magnesium carbonates and their like can also be used in the manufacture of our cement binder compositions.

| | Heating | |
|---|---|---|
| Starting material | conditions | Carbonate formula |
| MgCO₃•3H₂O | 105° C. for 1 hour | MgCO₃•3H₂O |
| MgCO₃•3H₂O | 105° C. for 3 hour | MgCO₃•2.64H₂O |
| MgCO₃•3H₂O | 105° C. for 6 hour | MgCO₃•2.19H₂O |
| MgCO₃•3H₂O | 105° C. for 12 | MgCO₃•1.76H₂O |
| | hour | |
| MgCO₃•3H₂O | 200° C. for 1 hour | MgCO₃•1.77H₂O |
| MgCO₃•3H₂O | 200° C. for 3 hour | MgCO₃•1.38H₂O |
| MgCO₃•3H₂O | 200° C. for 6 hour | MgCO₃•1.16H₂O |
| MgCO₃•3H₂O | 200° C. for 12 | MgCO₃•0.89H₂O |
| | hour | |
| MgCO₃•3H₂O | 400° C. for 1 hour | MgCO₃•0.95MgO |

Step (d) of the process disclosed herein comprises blending the magnesium carbonate(s) produced in step (b) or optional step (c) with at least magnesium oxide to produce a cement binder composition. In a more preferred embodiment of this step (d), and in accordance with our co-pending International Application PCT/EP2011/063629, a third component selected from one or more of the group consisting of silica, alumina, silicates, aluminates aluminosilicates, magnesite, magnesium hydroxide and pozzolans having a non-specific chemical composition is blended along with the magnesium carbonate and magnesium oxide. Suitably, the cement binder compositions produced by blending these three components together comprise (a) 30-80% by weight of the magnesium carbonates described above and magnesium oxide in total and (b) 20-70% by weight of the third component. Preferably the cement binder composition comprises 20-60% by weight of the third component, more preferably 25-45% and most preferably 25-40%. Exemplary preferred cement binder compositions are also those which contain 40-60% by weight of the magnesium carbonate(s) and magnesium oxide in total and 40 to 60% of the third component most preferably 45-55% in total of the former and 45 to 55% of the latter.

The relative proportions of the magnesium carbonate(s) and magnesium oxide in our cement binder compositions will depend to a certain extent on the amount of third component employed and the degree of crystallinity of the magnesium carbonate used.

With this in mind it has been found that the following broad compositional ranges (% by weight of their total) produce useful cement binders: (a) 5-90% of the magnesium carbonate(s) and (b) 10-95% of magnesium oxide. Within this broad envelope the following six typical composition ranges are preferred:

| Composition | | Magnesium Carbonate |
|---|---|---|
| Range. | MgO (% by weight). | (% by weight). |
| 1 | 10-30 | 70-90 |
| 2 | 30-50 | 50-70 |
| 3 | 40-50 | 50-60 |
| 4 | 50-60 | 40-50 |
| 5 | 50-70 | 30-50 |
| 6 | 70-90 | 10-30 |

As regards the third component, this preferably comprises one or more of quartz, cristobalite, fumed silicas, corundum, beta- and gamma- alumina, aluminosilicates such as clays, zeolites, spent catalytic cracking catalysts, metal silicates including but not limited to Group IA and IIA metal silicates e.g. sodium silicate. The third component may also comprise pozzolans having a variable and therefore non-specific physical or chemical composition e.g. slag, glass waste, fly ash and the like. Alternatively or additionally the third component may comprise one or more of magnesite, magnesium hydroxide or magnesium silicate (e.g. olivine or serpentine).

Typically step (d) is carried out by continuous or batch-wise mixing of the magnesium carbonate(s), magnesium oxide and optionally third components together in dry powder form in a stirred or agitated tank optionally together with up to 10% by weight (of the whole) of an alkali or alkaline-earth metal halide salt and/or other additives conventional in the art. The final formulated cement binder so produced can then be stored under dry conditions and/or bagged ready for sale to wholesale or end-users. It is especially useful in the manufacture of concretes, mortars and grouts for the building industry. The magnesium carbonate(s) produced by the process of the present invention, along with magnesium oxide, can also be used as additives to Portland cement to improve the latter's carbon footprint per unit tonne of material sold. If this approach is adopted then it is preferred that the Portland cement comprises no more than 50%, preferably less than 25% by weight of the total of the magnesium oxide and the magnesium carbonate(s).

In a further preferred embodiment of the present invention, the cement binder compositions comprise magnesium carbonate(s) and magnesium oxide which are both derived from magnesite, preferably a common source of magnesite thereby allowing the cement binder composition to be produced in a single integrated scheme.

The invention is now illustrated by the following Examples.

### EXAMPLE 1

Naturally occurring magnesite ore having an average particle size of 250 microns is pre-heated before being introduced into the top of a rotary kiln operating at 700° C. and 0.2 MPa where it is allowed to flow downwards under the influence of gravity to an exit pipe at the bottom where magnesium oxide is withdrawn either continuously or periodically. At the same, carbon dioxide gas is continuously removed overhead from the kiln. The carbon dioxide so recovered is then cooled against the incoming magnesite feed to the kiln, by means of a series of shell and tube heat exchangers to a temperature of 45° C. At the same time, the magnesium oxide recovered from the bottom of the kiln is likewise cooled down to 45° C. for example by cooling against cold water thereby raising steam which can be used elsewhere in the process for heating and power. 20% by weight of the magnesium oxide so produced is then dispersed as a 5% by weight suspension in water before being fed to a stainless-steel stirred pressure vessel where it is contacted with the cooled carbon dioxide gas recovered from the kiln at a temperature of 45° C. and 0.2 MPa. The residence time of the magnesium oxide feed in the reactor is five hours. The solids removed from the reactor at the end of this period are shown by X-ray powder diffraction to be nesquehonite.

### EXAMPLE 2

A mixture of 80 g of magnesium oxide (MgO—surface area of 30m²/g) and 20 g of nesquehonite (ex the carbonation of MgO) was added to 70 g of water and mixed for 5 minutes. The resulting mixture was cast into 10×10×60 steel moulds and cured in water. The samples achieved a compressive strength of 17 MPa after 28 days.

### EXAMPLE 3

A mixture of 80 g of MgO (surface area of 30 m²/g), 20 g of nesquehonite and 100 g of fly ash was added to 88 g of water and mixed for 5 minutes. The resulting mixture was cast into 10×10×60 steel moulds and cured in water. The samples achieved a compressive strength of 29 MPa after 28 days.

### EXAMPLE 4

A mixture of 96 g of MgO (surface area of 30 m²/g), 24 g of nesquehonite and 80 g of glass waste powder was added to 94 g of water and mixed for 5 minutes. The resulting mixture was cast into 10×10×60 steel moulds and cured in water. The samples achieved a compressive strength of 27 MPa after 28 days.

### EXAMPLE 5

A mixture of 80 g of MgO (surface area of 30 m²/g), 20 g of nesquehonite and 100 g of FCC was added to 94 g of water containing 2 g of superplasticiser and mixed for 5 minutes. The resulting mixture was cast into 10×10×60 steel moulds and cured in water. The samples achieved a compressive strength of 57 MPa after 7 days and 67 MPa after 28 days.

### EXAMPLE 6

A mixture of 80 g of MgO (surface area of 30 m²/g), 20 g of nesquehonite and 100 g of FCC was added to 114 g of water and mixed for 5 minutes. The resulting mixture was cast into 10×10×60 steel moulds and cured in water. The samples achieved a compressive strength of 47 MPa after 7 days and 61 MPa after 28 days.

### EXAMPLE 7

A mixture of 80 g of MgO (surface area of 30 m²/g), 20 g of thermally treated nesquehonite (MgCO₃ 1.8 H₂O) and 100 g of FCC was added to 112 g of water and mixed for 5 minutes. The resulting mixture was cast into 10×10×60 steel moulds and cured in water. The samples achieved a compressive strength of 37 MPa after 7 days.

1. A process for producing a cement binder composition comprising one or more magnesium carbonates having the general formula w MgCO₃ . x MgO . y Mg(OH)₂ . z H₂O in which w is a number equal to or greater than 1, at least one of x, y and z is a number greater than 0 and w, x, y and z may be (but need not be) integers wherein the process comprises the steps of (a) heating magnesite to liberate carbon dioxide gas and produce a solid product comprising magnesium oxide and (b) contacting an aqueous mixture comprising the magnesium oxide produced in step (a) with a source of carbonate ions at a temperature in the range 25 to 120° C. to produce at least one of the magnesium carbonates, (c) optionally heating the magnesium carbonate product(s) of step (b) at a temperature from 45 to 500° C. and (d) blending the magnesium carbonate(s) produced in step (b) or optional step (c) with at least magnesium oxide to produce a cement binder composition.

2. The process as claimed in claim 1 wherein in step (d) the magnesium carbonate is blended with magnesium oxide and a third component selected from one or more of the group consisting of silica, alumina, silicates, aluminates aluminosilicates, magnesite, magnesium hydroxide and pozzolans having a non-specific chemical composition.

3. The process as claimed in claim 1 wherein at least one of the magnesium carbonate(s) has the general formula MgCO₃.wH₂O wherein w is a number in the range 0.5 to 5.

4. The process as claimed in claim 3 wherein w is a number in the range 0.8 to 2.7.

5. The process as claimed in claim 3 wherein at least one of the magnesium carbonates is nesquehonite or a partially dehydrated version thereof.

6. The process a claimed in claim 1 wherein carbon dioxide is used in step (b) to generate the carbonate ions.

7. The process as claimed in claim 1 wherein the source of carbonate ions is either wholly or partially derived from a sodium or potassium carbonate or sodium or potassium bicarbonate salt.

8. The process as claimed in claim 1 wherein step (a) is carried out at a temperature in the range 550 to 800° C.

9. The process as claimed in claim 1 wherein step (b) is carried out at a temperature in the range 25 to 65° C.

10. The process as claimed in claim 1 wherein step (b) is carried out at a temperature in the range 65 to 120° C.

11. The process as claimed in claim 1 wherein step (c) is carried out at a temperature in the range 100 to 250° C.

12. The process as claimed in claim 1 wherein step (c) is carried out at a temperature in the range 250 to 400° C.

13. The process as claimed in claim 3 wherein the cement binder composition produced in step (c) comprises (a) 30-80% by weight magnesium carbonate(s) and magnesium oxide in total and (b) 20-70% by weight of the third component.

14. The process as claimed in claim 13 wherein the 30-80% by weight magnesium carbonate(s) and magnesium oxide in total comprises 5-90% of the magnesium carbonate(s) and 10-95% of magnesium oxide.

15. The process as claimed in claim 2 wherein the magnesium carbonate(s) and the magnesium oxide are both produced from magnesite.

16. The process as claimed in claim 2 wherein liberated carbon dioxide gas is used to heat the magnesite used in step (a).

17. The process as claimed in claim 1 wherein at least part of the carbon dioxide liberated in step (a) is to generate carbonate ions in step (b).
